(19) United States
(12) Patent Application Publication
(10) Pub. No.: US 2008/0072440 A1
(43) Pub. Date: Mar. 27, 2008

(54) Illuminated level

(76) Inventor: Bob Armitstead, Langley (CA)

Correspondence Address: Fasken Martineau DuMoulin LLP, 2100 - 1075 West Georgia Street, Vancouver, BC, V6E 3G2, US

(21) Appl. No.: 11/527,487

(22) Filed: Sep. 27, 2006

(51) Int. Cl. G01C 9/32

(52) U.S. Cl. 33/348

(57) ABSTRACT

A level is provided, comprising a casing having a flat surface; a first bubble level aligned approximately parallel with said flat surface; a first light positioned to illuminate said first bubble level; a switch, wherein when said switch is actuated, said light illuminates said level; and a power source for said light.

### FIELD OF THE INVENTION

This invention relates to levels, and particularly to levels adapted for use in darkened conditions.

### BACKGROUND OF THE INVENTION

Levels have been used in the construction and carpentry industries for many years and are provided in a variety of styles, including hand held beam levels, string levels, torpedo levels, fish eye levels, and water levels.

The hand held beam style level is the most commonly used level in construction and carpentry; it is lightweight, durable, easy to use and affordable. Some examples of use of the hand held beam level include levelling concrete, laying foundations, laying tile, hanging doors, installing shelves, mounting cabinets, installing counter tops and many other building and installation projects. One disadvantage of the hand held beam style level is that it is difficult to read in low light conditions common in construction sites.

Most levels use bubbles placed within bubble levels to indicate when a surface is horizontal or vertical, depending on the placement of the bubble. When the bubble is centered within the buble level, the surface is “level”.

### BRIEF SUMMARY OF THE INVENTION

The illuminated level according to the invention is a hand held beam style level that generally performs the same functions as a standard hand held beam level. The level according to the invention is light weight, durable, easy to use and also affordable but, unlike currently available levels, is useable in low light conditions or against dark back grounds such as concrete, and also on dark woods like walnut, dark mahogany, or dark oak. The level according to the invention can also be used in areas in which it may be difficult to view, such as closets, basements, inside cupboards, dark hallways and under sinks.

The illuminated level preferably includes a LED light within the level positioned adjacent to a bubble level, so that in low light conditions the user can actuate a switch located at the end of the beam level to turn on the LED light. This allows for the user to see the bubble clearly, and when the light is not required the user can simply actuate the switch to the off position.

The illuminated level is easy to use and will save time and effort when a job is done in poor light conditions. In many cases job sites lack adequate lighting making the illuminated level useful.

A beam level is provided, including a casing having a flat surface; a first bubble level aligned approximately parallel with said flat surface; a first light positioned to illuminate said first bubble level; a switch, wherein when said switch is actuated, said light illuminates said bubble level; and a power source for said light. The power source may be a battery, particularly a rechargeable battery.

A second bubble level may be provided therein, aligned approximately perpendicular to said flat surface. A second light may be positioned to illuminate said second bubble level, said second light illuminating said second bubble level when said switch is actuated.

The switch may be positioned at an end of said casing and the casing may be hollow.

The first and second bubble levels may be positioned within first and second bubble housings, respectively, and said first and second bubble housings may be positioned within first and second positioning rings, respectively.

The level may include a third bubble level aligned approximately parallel to said flat surface and a third light positioned to illuminate said third bubble level, said third light illuminating said third bubble level when said switch is actuated. The third bubble level may be positioned within a third bubble housing, and said third bubble housing is positioned within a third positioning ring.

The casing may have an elongated cubical shape and the second bubble level may be positioned between said first and third bubble levels.

### BRIEF DESCRIPTION OF THE DRAWINGS

FIG. 1 is a front view of an illuminated level in a preferred embodiment according to the invention;

FIG. 2 is a perspective view of the casing thereof;

FIG. 3 is a front view thereof, showing the battery case;

FIG. 4 is view of the LEDs, battery and switch therein;

FIG. 5 is a side view of the switch therefor;

FIG. 6 is an end view of the switch therefor;

FIG. 7 is an exploded view of a positioning ring, and contents thereof;

FIG. 8 is a side view of an aluminium tube and bubble level therein;

FIG. 9 is a top view thereof; and

FIG. 10 is an sid view of of a positioning ring, and contents thereof.

### DETAILED DESCRIPTION OF THE INVENTION

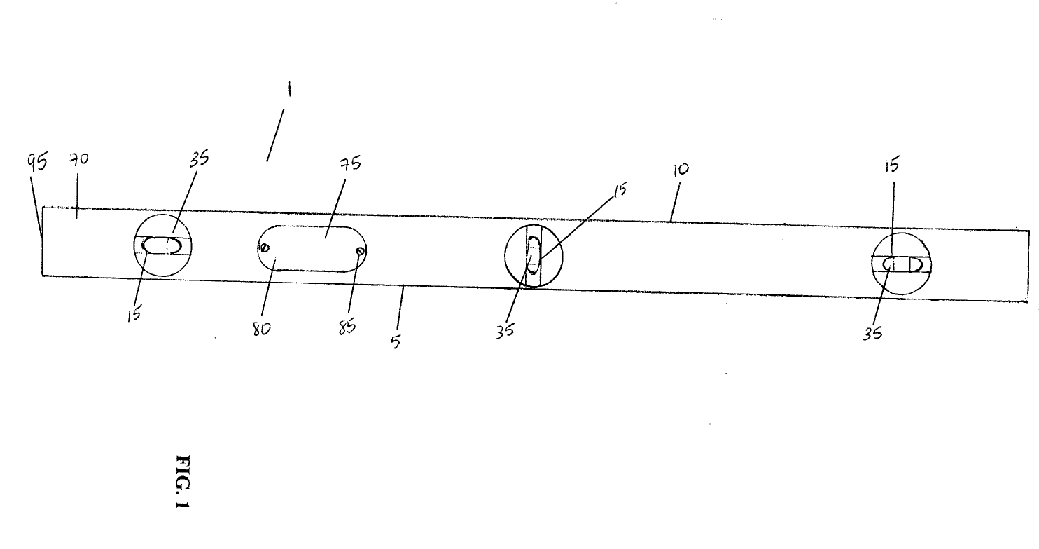

As seen in FIG. 1, the illuminator level according to the invention, generally indicated as 1, is a standard hand held beam style level. It includes a casing 10, preferably made of lightweight aluminium, although hardened plastic, wood, or other metals would also be suitable. Casing 10 is preferably an elongated cubical shape, although other shapes having at least a single flat surface 5 may also be used. As shown in the Figures, casing 10 is hollow, although casing 10 may also be a solid structure with openings to allow viewing of bubbles 35.

Level 1 includes at least one, and preferably three bubble levels 15 containing a bubble 35. In alternative embodiments, level 1 may include different numbers of bubble levels 15 as needed, typically one to three, and rarely should more than four bubble levels be required. Preferably each bubble level 15 includes a LED light 30, although in alternative embodiments one or more of bubble levels may not include a light, as long as at least one bubble level includes a light. Each LED 30 is situated to illuminate bubble 35 allowing bubble 35 to be seen clearly in dark surroundings when LEDs 30 are turned on. A shown in FIG. 1, the bubble levels 15 may be positioned horizontally or vertically relative to flat edge 5.

Bubble levels 15 are typically placed in alignment (i.e. approximately parallel) with a horizontal surface (such as flat edge 5) so that the bubble level can be used to determine when that surface is level. In level 1, a bubble level is placed perpendicular to flat edge 5, so that the particular bubble level can be used to determine when flat end edge 95 is level.

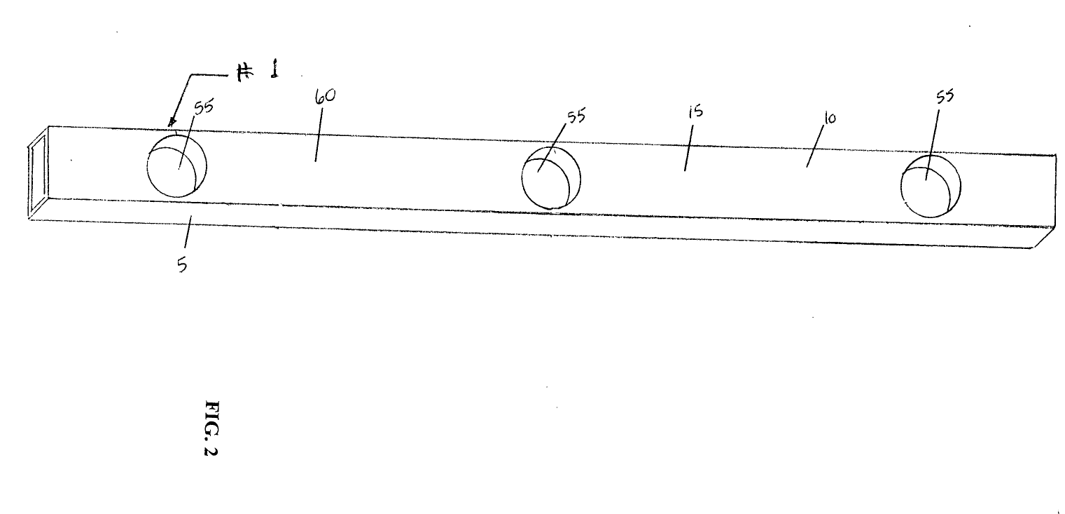

As seen in FIG. 2, casing 10, if it is hollow as shown in FIG. 2, preferably includes three pairs of apertures 55, each pair aligned on first and second sides 65, 70 of casing 10. Each aperture 55 is sized to receive and engage a positioning ring 60.

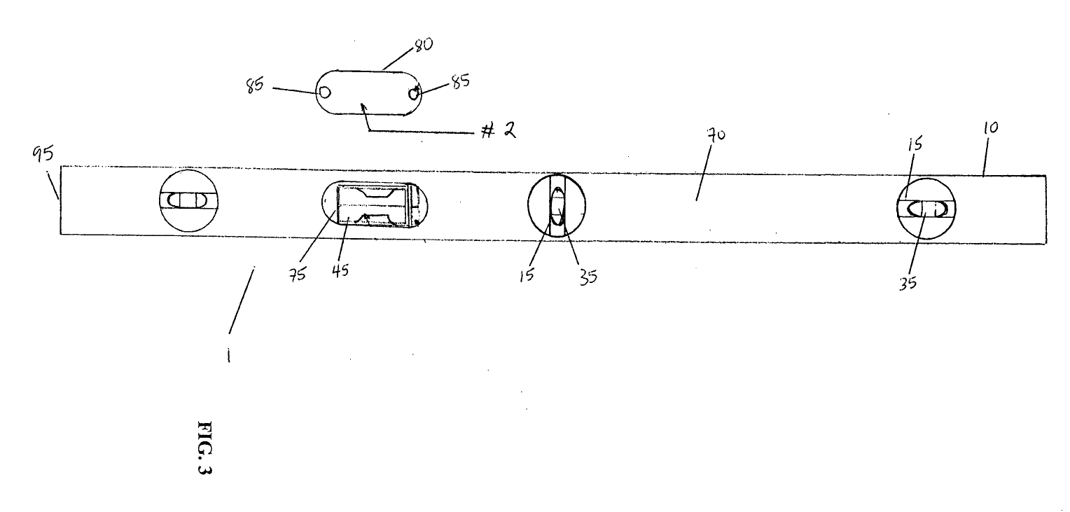

As seen in FIG. 3, on second side 70 of casing 10, battery holder 75 is accessible. Battery holder receives batteries 45 and may be covered by removable battery cover plate 80. Batteries 45 are preferably 2 AA cell batteries, although other types of batteries may be used for power. Batteries 45 may be easily replaced when needed as the batteries become low, simply by removing battery cover plate 80, typically held to casing 10 by screws 85 although a snap-on cover could also be used, removing the old batteries and replacing them with new batteries.

While the LEDs are preferably powered by batteries, alternate power sources may also be used. For example, the level may include a plug so that it can be plugged into a convenient outlet. Typically batteries are the preferred power source, as the level may be used in locations where electrical outlets are inconveniently placed, or even inaccessible. In an alternative embodiment batteries 45 may be rechargeable, and the level would be sold with a recharger to allow users to maintain battery strength.

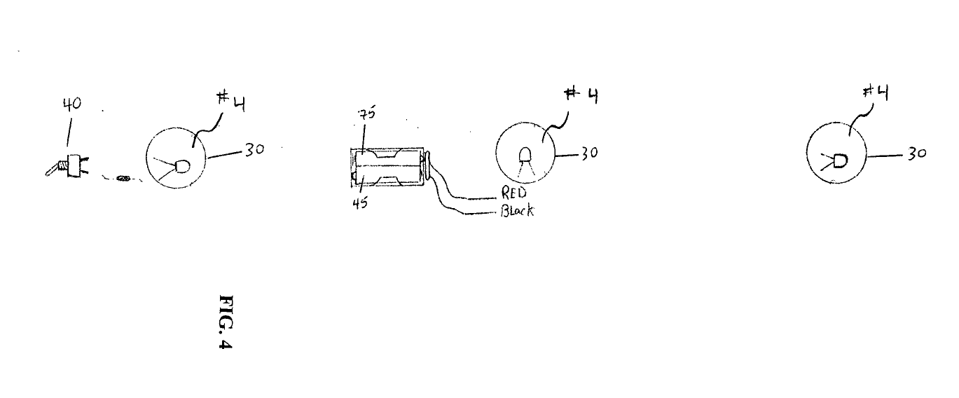

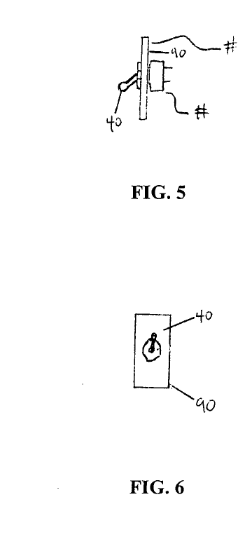

As seen in FIG. 4, preferably switch 40 is used to turn LEDs 30 on and off. Switch 40 is preferably located at an end 35 of level 1. LEDs 30 are preferably mini lamp 3 volt LEDs although other lights with other amplitudes and voltages may be used including mini krypton bulbs, and are powered by batteries 45. FIGS. 5 and 6 show side and end views of switch 40. Switch 40 is mounted on mounting plate 90 for insertion into flat end 95 of casing 10.

Alternatively switch 45 may be of a “button” type, or there may be more than one switch present, one for each LED in level 1.

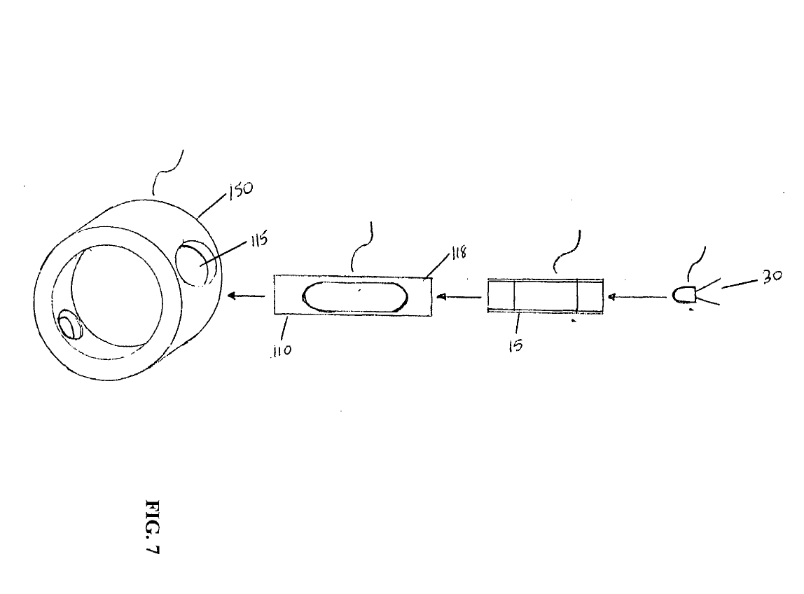

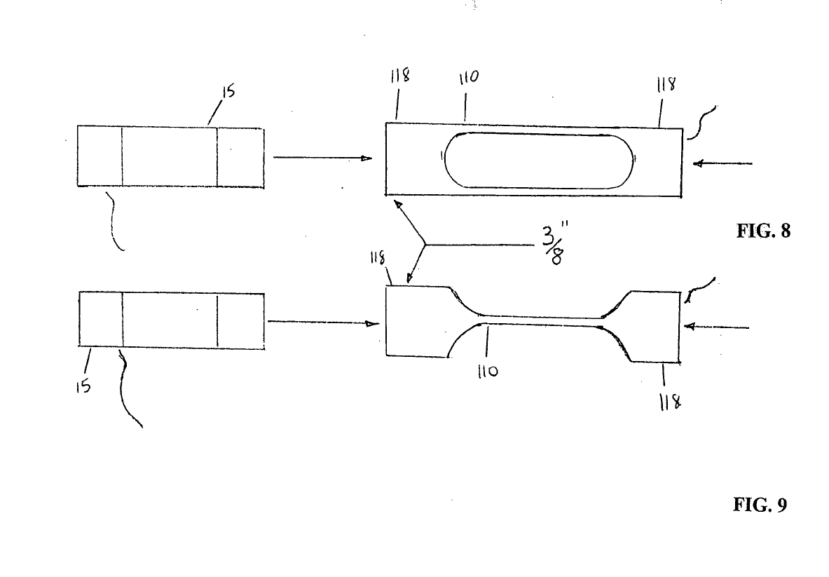

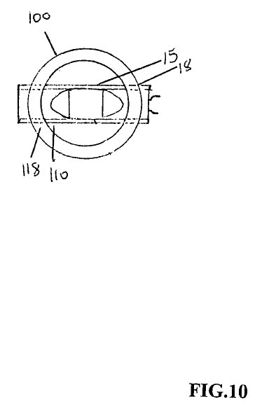

As best seen in FIG. 7, LEDs 30 and bubble levels 15 are preferably mounted in casing 10 by use of positioning rings 100. Positioning ring 100 includes apertures 115 shaped to receive ends 118 of bubble housing 110. Bubble level 15 is positioned and held within bubble housing 110, as seen in FIGS. 8 and 9, and LED 30 may be placed to one side of bubble housing 110, as seen in FIG. 10. Bubble housing 110 is preferably an aluminium tube with cut away sides to allow bubble level 15 to be viewed from two sides. In alternative embodiments, LEDs 30 may be placed in different positions relative to bubble level 15.

Rather than mounting LEDs and bubble levels in level 1 via positioning rings other means may be used, including mounting the bubble housing in anextruded clear plastic holder, epoxing the the bubble level in aperture 55. In other alternative embodiments, the bubble levels may be held in place by grout and a transparent plastic or glass surface is placed on either side of aperture 55. In yet another alternative embodiment, the level bubble can be installed in an adjustable insert which is then positioned in the casing, allowing for future adjustment of the bubble if needed.

Although the particular preferred embodiments of the invention have been disclosed in detail for illustrative purposes, it will be recognized that variations or modifications of the disclosed apparatus lie within the scope of the present invention.

The invention claimed is:

1. A level comprising:
(a) a casing having a flat surface;
(b) a first bubble level aligned approximately parallel with said flat surface;
(c) a first light positioned to illuminate said first bubble level;
d) a switch, wherein when said switch is actuated, said light illuminates said level; and
e) a power source for said light.

2. The level of claim 1 wherein said power source is a battery.

3. The level of claim 2, wherein said power source is a rechargeable battery.

4. The level of claim 3, further comprising a second bubble level, aligned approximately perpendicular to said flat surface.

5. The level of claim 4, further comprising a second light positioned to illuminate said second bubble level, said second light illuminating said second bubble level when said switch is actuated.

6. The level of claim 5, wherein said switch is positioned at an end of said casing.

7. The level of claim 6 wherein said casing is hollow.

8. The level of claim 7 wherein said first bubble level is positioned within a first bubble housing, and said bubble housing is positioned within a first positioning ring.

9. The level of claim 8 wherein said second bubble level is positioned within a second bubble housing, and said second bubble housing is positioned within a second positioning ring.

10. The level of claim 9, further comprising a third bubble level aligned approximately parallel to said flat surface.

11. The level of claim 10, further comprising a third light positioned to illuminate said third bubble level, said third light illuminating said third bubble level when said switch is actuated.

12. The level of claim 11 wherein said third bubble level is positioned within a third bubble housing, and said third bubble housing is positioned within a third positioning ring.

13. The level of claim 12 wherein said casing is an elongated cubical shape.

14. The level of claim 13 wherein said second bubble level is positioned between said first and third bubble levels.
